(19) United States
(12) Patent Application Publication
(10) Pub. No.: US 2008/0090111 A1
(43) Pub. Date: Apr. 17, 2008

(54) FUEL CELL SYSTEM AND METHOD OF OPERATING THE SAME

(75) Inventors: Young-jae Kim, Yongin-si (KR); Jae-yong Lee, Yongin-si (KR); Jin-ho Kim, Yongin-si (KR); Hye-jung Cho, Yongin-si (KR); Lei Hu, Yongin-si (KR); Young-soo Joung, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/778,317

(22) Filed: Jul. 16, 2007

(30) Foreign Application Priority Data
Oct. 17, 2006 (KR) 2006-101046

(51) Int. Cl. H01M 8/04

(52) U.S. Cl. 429/13; 429/24

(57) ABSTRACT

A fuel cell system to rapidly increase the temperature of unit cells. The fuel cell system includes; a plurality of current generating unit cells; a load circuit to supply the current to a load; a short circuit to connect the cells to an electrically closed loop without passing through the load; a thermo sensor to measure the temperature of the cells, and a controller that controls the delivery of the current to the load circuit and the short circuit, according to the temperature measured by the thermo sensor. The fuel cell system can rapidly increase the temperature of the unit cells when the temperature of the unit cells is below an operating temperature, thereby reducing the time required for the fuel cell to generate a stable output voltage.

### CROSS-REFERENCE TO RELATED APPLICATIONS

This application claims the benefit of Korean Patent Application No. 2006-101046, filed on Oct. 17, 2006, in the Korean Intellectual Property Office, the disclosure of which is incorporated herein by reference.

### BACKGROUND OF THE INVENTION

1. Field of the Invention

Aspects of the present invention relate to a fuel cell system and a method of operating the same.

2. Description of the Related Art

A fuel cell is an electric generator that converts the chemical energy of a fuel into electrical energy through a chemical reaction. A fuel cell can continuously generate electricity for as long as fuel is supplied thereto. FIG. 1 is a schematic drawing illustrating the energy transformation structure of a fuel cell. Referring to FIG. 1, when air that includes oxygen is supplied to a cathode 1, and a fuel containing hydrogen is supplied to an anode 3, electricity is generated by the reverse electrolysis of water through an electrolyte membrane 2. However, conventionally, a unit cell 10 does not generate a useable high voltage. Therefore, electricity is generated by a stack of unit cells 10 connected in series.

A fuel cell can perform a normal operation when the temperature of the unit cells 10 is maintained at or above an appropriate operating temperature. Therefore, when the unit cells 10 are not preheated before beginning fuel cell operation, the normal power output of the unit cells is not generally produced. Accordingly, at the beginning of the operation, an electrochemical reaction is generated in the unit cells 10 without applying a load. When the temperature of the unit cells 10 reaches an appropriate temperature, the fuel cell may be operated with a load. In a direct methanol fuel cell (DMFC) that uses methanol as a hydrogen source, a fuel supplied to the anode 3 reacts with a catalyst in the cathode 1, by passing through the electrolyte membrane 2. This cross-over reaction occurs regardless of the connection of a load. Since the cross-over reaction is an exothermic reaction, the temperature of the unit cells 10 increases as the fuel is supplied. Accordingly, a desirable method of operating the fuel cell is that, after starting up the fuel cell, an electrical apparatus to be supplied with power is not connected to the fuel cell until the temperature of the unit cells 10 reaches a desired operating temperature. When the temperature reaches a desired level, that is, when an output current is stable enough to be supplied to an electrical apparatus due to the increase in the temperature, a load is connected.

However, when a fuel cell system is configured and operated as described above, the preheating time is long. FIG. 2 is a graph showing the measurement results of temperature vs. voltage of each unit cell when a normal operation begins. The normal operation includes connecting a load after the temperature of the fuel cell reaches a normal operating temperature, for example, 50° C., after starting a passive-type DMFC by supplying fuel to the unit cells 10. When fuel is supplied to the unit cells 10, an electrochemical reaction occurs, and thus, a voltage is generated. Assuming that a voltage Vₜₕ, that is, an open circuit voltage (OCV) (hereinafter, an operating voltage) of each of the unit cells 10 that enables the fuel cell to operate in normal operation, is approximately 0.5V, the time to reach the operating voltage is approximately 5 minutes. Therefore, the time needed for the unit cells 10 to reach the operating voltage Vₜₕ is not a significant loss of time for operating the fuel cell. However, as depicted in FIG. 2, the increase in temperature is very slow. It takes almost 50 minutes to reach a temperature Tₜₕ (hereinafter, an operating temperature) at which a load can be applied. That is, a load can only be applied to the fuel cell almost one hour after start up of the fuel cell.

In addition, there is a possibility that the temperature of the unit cells, during operation in very cold conditions, may be reduced below the normal operating temperature. In this case, if the temperature is not increased rapidly, the power supplied to an electrical apparatus can be intermittently stopped.

Therefore, in order to solve these and/or other problems, there is a need to develop a fuel cell system and a method of heating a fuel cell that can rapidly heat the unit cells when the temperature of the unit cells is below the normal operating temperature.

### SUMMARY OF THE INVENTION

Aspects of the present invention provide a fuel cell system that can rapidly increase the temperature of unit cells when necessary, and a method of operating the fuel cell.

According to an aspect of the present invention, there is provided a fuel cell system comprising: a plurality of cells in which a power generation reaction occurs; a load circuit that forms a load path to supply a current to a load by electrically connecting the cells to a load; a short circuit that connects the cells to an electrically closed loop, without passing through the load; a thermo sensor that measures the temperature of the cells; and a controller that controls the delivery of a current generated from the cells to one of the load circuit and the short circuit, according to the temperature measurement of the thermo sensor.

The plurality of cells may be connected in series. The short circuit may comprise a unit cell short circuit that connects an anode and a cathode of each of the cells in a closed loop, and a stack short circuit that connects a terminal of an end of an uppermost cell and a terminal of an end of a lowermost cell, of the cells connected in series.

According to an aspect of the present invention, there is provided a method of operating a fuel cell system comprising: performing a normal operation in which a current is supplied to a load, by electrically connecting cells to the load when a measured temperature of the cells is higher than an appropriate temperature; and rapidly heating the cells using a short circuit that bypasses the load when the measured temperature of the cells is lower than the appropriate temperature.

The rapid heating of the cells may be performed by repeatedly turning the short circuit ON and OFF.

With regard to repeatedly turning the short circuit ON and OFF, each of the cells may comprise an individual short circuit, and the process of repeatedly turning ON and OFF of the short circuit may be sequentially performed by sequentially turning the short circuit for each of the cells ON and OFF.

The plurality of cells may be connected in series to one short circuit, and the process of repeatedly turning ON and OFF of the short circuit may be performed by turning the entire short circuit ON and OFF.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic drawing illustrating the energy transformation structure of a fuel cell;

FIG. 2 is a graph showing the measurement result of the variation of temperature and voltage in a conventional fuel cell;

FIG. 3 is a block diagram showing an overall configuration of a fuel cell system according to an embodiment of the present invention;

FIG. 4 is a flow chart showing an operation process using the fuel cell system illustrated in FIG. 3;

FIG. 5 is a timing graph showing an ON and OFF method of a short circuit in the fuel cell system illustrated in FIG. 3; and

FIG. 6 is a graph showing the variation of temperature and voltage of the fuel cell system illustrated in FIG. 3, compared to that of the conventional fuel cell system.

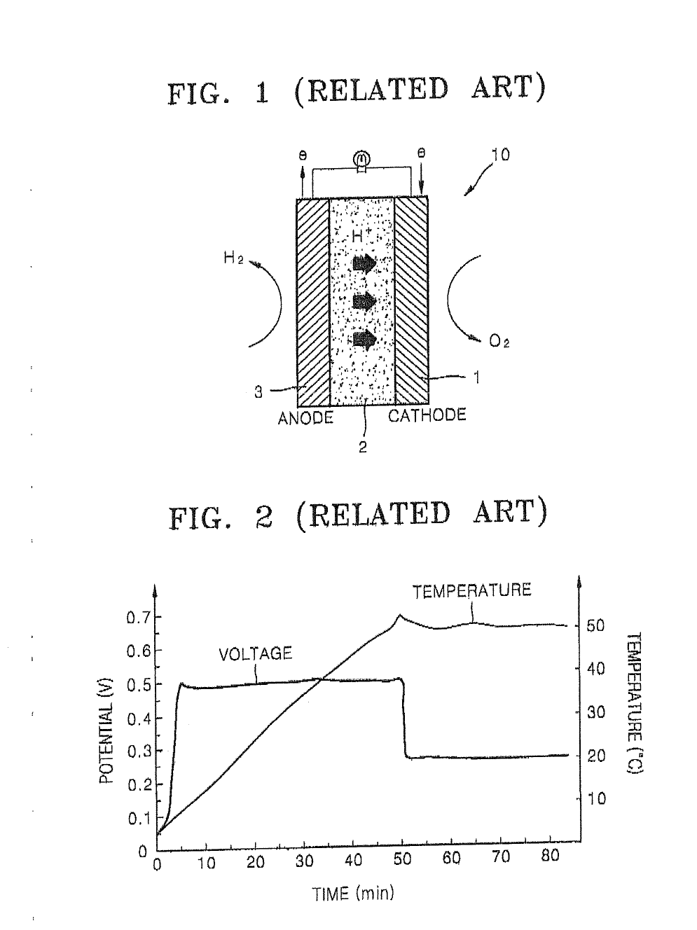

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

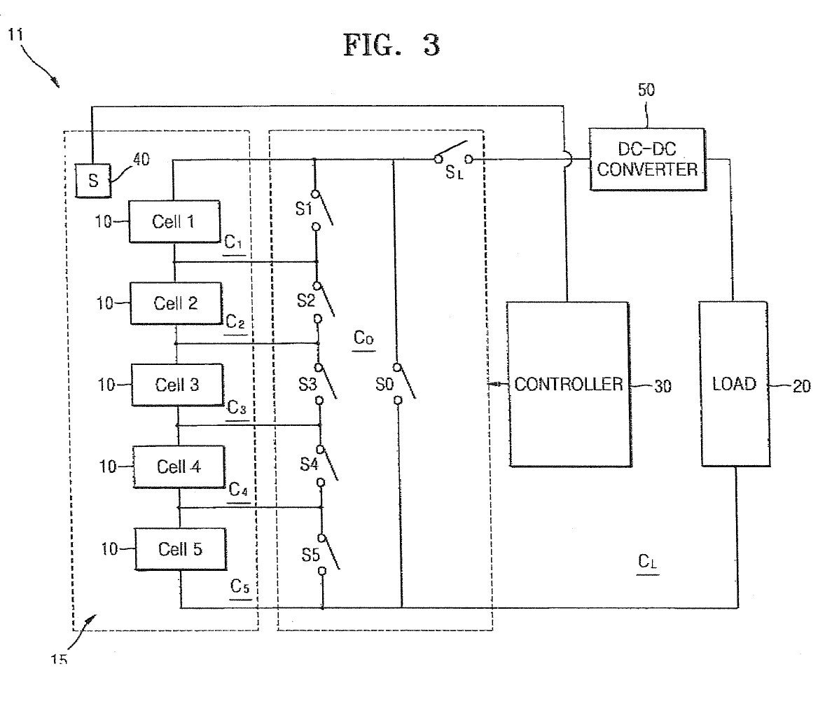

FIG. 3 is a block diagram showing an overall configuration of a fuel cell system 11 according to an embodiment of the present invention.

The fuel cell system 11 comprises: a plurality of unit cells 10 disposed in a stack 15; a load 20; a controller 30; a temperature sensor 40; and a DC-DC converter 50. The stack 15 comprises a stack anode and a stack cathode. The unit cells 10 can be connected to one another in series. Each of the unit cells 10 comprises a cell anode and a cell cathode. The load 20 can comprise any electrical device that provides resistance to an electrical current, for example, a motor or any other electrically operated device that provides a resistance, other than a switch.

The fuel cell system 11 has a basic structure in which the current generated in the stack 15, is selectively supplied to the load 20, under the control of the controller 30. In FIG. 3, the stack 15 includes 5 unit cells 10 connected in series, but the number of the unit cells 10 in the stack 15 can be increased or decreased according to a desired electrical output.

The fuel cell system 11 can comprise short circuits C₀-C₅ and a load circuit C_{L}. The short circuits C₁-C₅ can be referred to as unit cell short circuits C₁-C₅, and the short circuit C₀ can be referred to as a stack short circuit C₀. Each of the unit cell short circuits C₁-C₅ respectively comprises a switch S₁-S₅. The stack short circuit C₀ comprises a switch S₀. The load circuit C_{L} comprises a switch S_{L}. Each of the unit cell short circuits C₀-C₅ comprises a direct connection between the anode and the cathode of a respective unit cell 10. The stack short circuit C₀ comprises a direct connection between the anode and cathode of the stack 15. Herein, a direct connection and/or directly connecting can refer to an electrical connection that does not pass through a load.

The unit cell short circuits C₁-C₅ and/or the stack short circuit C₀ can rapidly increase the temperature of the unit cells 10, The unit cell short circuits C₁-C₅ are completed by closing the switches S₁-S₅. The stack short circuit C₀ is completed by closing the switch S₀. When the switches S₀-S₅ are closed, the current generated in the unit cells 10 flows through the short circuits C₀-C₅, without passing through the load 20 (a no load state). When the current flows through the short circuits C₀-C₅ in a no load state, the temperature of the unit cells 10 increases faster than when the current passes through the load circuit C_{L} is connected to the load 20, or when the circuit is completely open. This is because, as described above, the electrochemical reaction in the unit cells 10 is an exothermic reaction, and the short circuit itself is an extremely exothermic circuit, that is, all or nearly all the electric energy generated in the unit cells 10 is transformed into heat. The temperature of the unit cells 10 is measured using a thermo sensor 40, mounted on the stack 15. When an increase in temperature is needed, the controller 30 closes the switches S₀-S₅ of the short circuits C₀-C₅, to increase the temperature of the unit cells 10. In this way, a selective temperature control can be performed. The DC-DC converter 50 reduces the fluctuation of voltage applied to the load 20 by the load circuit C_{L}.

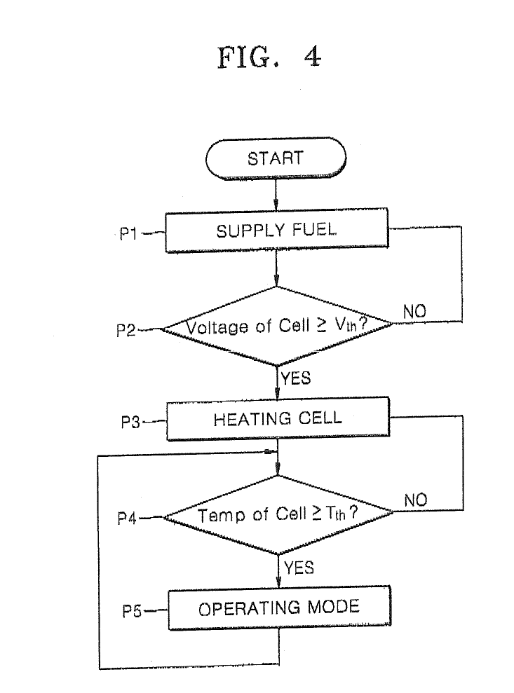

Rapidly raising the temperature of the unit cells 10 is often useful at an initial start up operation, when warming the unit cells 10 is necessary. FIG. 4 is a flow chart showing a method of rapidly increasing the temperature of the unit cells 10 at an initial start up.

Referring to FIG. 4, the method comprises an operation P1 where fuel is supplied to the unit cells 10, in order to generate a power generation reaction in the unit cells 10. At this point, the switches S₀-S₅ and S_{L}, are in an open state. In an operation P2, the voltage of the unit cells 10 is detected. When the voltage generated by the unit cells 10 reaches an operating voltage Vₜₕ, an operation P3 begins a rapid temperature increase by turning ON the short circuits C₀-C₅ by closing stitches S₀-S₅.

The operation P2 can further comprise detecting the temperature of the unit cells 10. If the temperature of the unit cells is less than an operating temperature, the method will proceed to operation P3. If the temperature is greater than or equal to an operating temperature, the method will proceed to an operation P5, discussed below.

The operation P3 can comprise using the controller 30 to control the actuation of the switches S₀-S₅, of the short circuits C₀-C₅. The current generated in the unit cells 10 flows through the short circuits C₀-C₅. Accordingly, the temperature in the unit cells 10 rapidly increases due to the transformation of electrical energy into heat, in addition to an exothermic reaction for power generation. Whether to establish the electrical connections through the short circuits C₀-C₅ is determined by measuring the temperature of the unit cells 10 with the thermo sensor 40. That is, the temperature measured by the thermo sensor 40 is compared to a set value, and when the temperature of the unit cells 10 is lower than the set value, the controller 30 closes the switches S₀-S₅ to connect the short circuits C₀-C₅. The switches S₀-S₅ may be periodically opened and closed instead of being maintained in a closed (ON) state for a long period of time, e.g., an hour. This is because, as described above, the short circuits C₀-C₅ are extremely exothermic circuits, and when the ON state is maintained for a long period of time, the unit cells 10 may be damaged by overheating. A method of repeatedly closing and opening (turning ON and OFF) the short circuits C₀-C₅ can include a variable duty method. The variable duty method can comprise maintaining a constant ON and OFF frequency. The ON time and OFF time of the short circuits C₀-C₅ can be varied, within a unit frequency, or within a variable frequency method in which the ON and OFF frequency is varied.

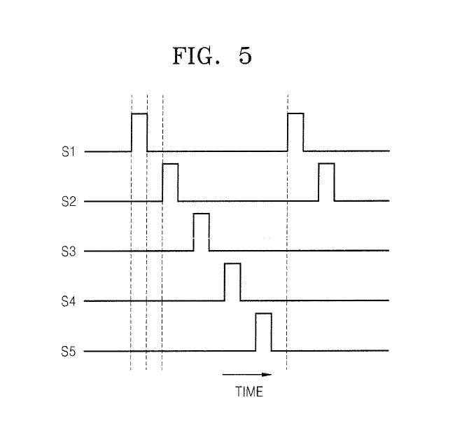

The repeated turning ON and OFF of the short circuits C₀-C₅ can be performed by using the stack short circuit C₀, by closing and opening (turning ON and OFF) the switch S₀. In addition, as shown in FIG. 5, each of the short circuits C₁-C₅ can be independently cycled ON and OFF by sequentially turning the switches S₁-S₅ ON and OFF.

When the short circuits C₀-C₅ are repeatedly turned ON and OFF, the temperature of the unit cells 10 rapidly increases, due to the transformation of electrical energy into heat, in the short circuits C₀-C₅ in addition to an exothermic reaction for power generation. In an operation P4, the temperature of the unit cells 10 is detected as the short circuits C₀-C₅ are cycled ON and OFF. When the temperature in the unit cells 10 reaches an operating temperature Tₜₕ, the controller 30 shuts off all the short circuits C₀-C₅, and closes the switch S_{L} of the load circuit CL. Closing the switch SL allows the current generated from the unit cells 10 to be supplied to a load, thereby performing an operation P5 (normal operation).

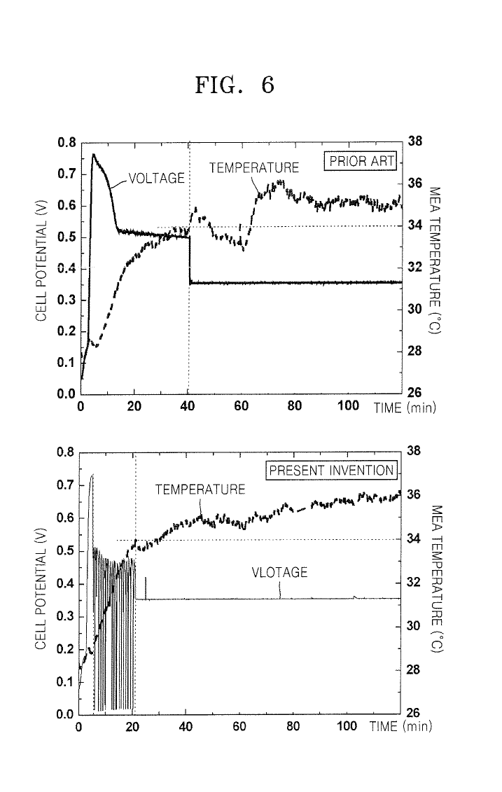

FIG. 6 is a graph showing the comparison of the temperature increase at the initial start up of a conventional fuel cell system, and the temperature increase of a fuel cell system having a short circuit according to an embodiment of the present invention. The graph shows an assumed operating temperature of 34° C. In the case of the present embodiment, for a rapid increase in the temperature of the unit cells, an ON state of the short circuit is maintained for 0.1 seconds per second. The conventional fuel cell system took approximately 40 minutes for its unit cells to reach the operating temperature. However, the present embodiment took only approximately 20 minutes, which is about half of the warm up time of the conventional fuel cell system. This time difference is due to the additional heat from the short circuits, and the exothermic power generation reaction. Thus, the warm up time at the initial start up of a fuel cell system can be greatly reduced.

In the present teachings, the use of a short circuit for warm up at the initial start up of a fuel cell system has been described. However, a rapid temperature increasing process can also be performed during normal operation, by connecting the unit cell short circuits C₁-C₅. For example, the temperature of a fuel cell may drop below the operating temperature if the fuel cell is operated in cold conditions. The temperature of the unit cells 10 can be rapidly increased by connecting the unit cell short circuits C₁-C₅. If the stack short circuit C₀ is turned ON and OFF, the voltage generated from the stack 15 can fluctuate to a large degree. However, when the unit cell short circuits C₁-C₅ of the unit cells 10 are alternately and/or sequentially turned ON and OFF, the fluctuation of the voltage may not affect the load since the fluctuation can be sufficiently compensated for by the DC-DC converter 50. For example, the converter 50 can mitigate the instant voltage fluctuation of the load circuit C_{L}.

Accordingly, a fuel cell system that can rapidly increase the temperature of unit cells as necessary, and a method of operating the fuel cell system can be realized.

As described above, a fuel cell system and a method of operating the fuel cell system according to aspects of the present invention has the following advantages. First, a warm up time at the initial start up of the fuel cell system can be greatly reduced since the unit cells can be rapidly heated using short circuits. Second, the fuel cell system is useful in cold weather since the temperature of unit cells can be rapidly increased if the temperature falls during normal operation due to the cold weather.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell system comprising:
a plurality of unit cells to generate a current;
a load circuit to connect the unit cells to a load;
at least one short circuit to connect the unit cells to an electrically closed loop without passing through the load;
a thermo sensor to measure the temperature of the unit cells; and
a controller to selectively control the delivery of the current from the unit cells to the load circuit and the at least one short circuit, according to the temperature measured by the thermo sensor.

2. The fuel cell system of claim 1, wherein the plurality of unit cells are connected in series,
wherein the at least one short circuit comprises:
a plurality of unit cell short circuits to connect an anode and a cathode of each of the unit cells; and
an stack short circuit to connect a terminal of an end of a first unit cell and a terminal of an end of a last unit cell, of the unit cells connected in series.

3. A method of operating a fuel cell system comprising:
performing a normal operation in which a current is supplied to a load by electrically connecting unit cells to the load when a measured temperature of the unit cells is higher than an appropriate temperature; and
heating the unit cells using a short circuit that bypasses the load when the measured temperature of the unit cells is lower than the appropriate temperature.

4. The method of claim 3, wherein the heating of the unit cells is performed by repeatedly turning the short circuit ON and OFF.

5. The method of claim 4, wherein each of the unit cells comprises an individual short circuit, and the process of repeatedly turning ON and OFF of the short circuit is sequentially performed by turning the unit cells ON and OFF.

6. The method of claim 4, wherein the plurality of unit cells are connected in series to one short circuit, and the process of repeatedly turning ON and OFF of the short circuit is performed by turning the one short circuit ON and OFF.

7. The fuel cell system of claim 1, wherein the at least one short circuit comprises a plurality of unit cell short circuits to directly connect an anode and a cathode of each of the unit cells.

8. The fuel cell system of claim 7, wherein each unit cell short circuit further comprises a switch.

9. The fuel cell system of claim 1, wherein the plurality of unit cells are connected in series,
wherein the at least one short circuit comprises a stack short circuit to connect a terminal of an end of a first unit cell and a terminal of an end of a last unit cell, of the unit cells connected in series.

10. The fuel cell system of claim 9, wherein the stack short circuit comprises a switch.

11. The fuel cell system of claim 1, further comprising a DC-DC converter to compensate for voltage fluctuations in the load circuit.

12. The fuel cell system of claim 1, wherein the load circuit further comprises a switch.

13. The fuel cell system of claim 2, wherein the unit cell short circuits and the stack short circuit are electrically connected.

14. A method of operating a fuel cell system comprising a stack of unit cells, at least one short circuit, and a load circuit, the method comprising:
supplying a fuel to the stack;
detecting the voltage of a current produced by the stack;
heating the unit cells using the at least one short circuit in response to the detected voltage; and
applying the current to the load circuit.

15. The method of claim 14, wherein the heating of the unit cells occurs only if the detected voltage is greater than or equal to an operating voltage.

16. The method of claim 14, further comprising detecting the temperature of the unit cells during the heating of the unit cells.

17. The method of claim 16, wherein the applying of the current occurs only if the detected temperature of the unit cells is greater than or equal to an operating temperature.

18. The method of claim 14, further comprising detecting the temperature of the unit cells before heating the unit cells.

19. The method of claim 18, wherein the heating of the unit cells does not occur if the detected temperature is greater than or equal to an operating temperature, and the method then proceeds to the applying of the current.

20. The method of claim 14, further comprising detecting the temperature of the unit cells after the applying of the current.

21. The method of claim 20, further comprising repeating the heating of the unit cells if the detected temperature of the unit cells is less than an operating temperature.

22. The method of claim 14, wherein:
the at least one short circuit comprises one short circuit for each unit cell; and
the heating of the unit cells comprises sequentially opening and closing the short circuits.

23. The method of claim 14, wherein the heating of the unit cells comprises sequentially opening and closing the at least one short circuit.
